(19) United States
(12) Patent Application Publication
(10) Pub. No.: US 2007/0110195 A1
(43) Pub. Date: May 17, 2007

(54) RECEIVER AND COMMUNICATION SYSTEM

(75) Inventor: Hirotsugu KAJIHARA, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-Ku (JP)

(21) Appl. No.: 11/539,217

(22) Filed: Oct. 6, 2006

(30) Foreign Application Priority Data
Oct. 20, 2005 (JP) 2005-305827

(51) Int. Cl. H04L 1/02

(52) U.S. Cl. 375/347

(57) ABSTRACT

According to the present invention, there is provided a receiver comprising: a decoding unit having a quasi-maximum-likelihood decoder which receives a plurality of transmission signals transmitted simultaneously from a plurality of antennas, decodes the transmission signals using a searching algorithm, and outputs decoded signals, an error packet data storage unit which stores packet data with an error from the quasi-maximum-likelihood decoder when a packet error exists in the decoded signals, and a control unit which controls operations of the quasi-maximum-likelihood decoder and the error packet data storage unit; a receiving unit which receives the decoded signals, and when a packet error exists in the decoded signals, outputs a packet error detection signal to the control unit, wherein when said receiving unit outputs the packet error detection signal and receives re-transmitted transmission signals, the re-transmitted transmission signals are decoded using the error packet stored in the error packet data storage unit as a start point for search.

### CROSS REFERENCE TO RELATED APPLICATION

This application is based upon and claims benefit of priority under 35 USC § 119 from the Japanese Patent Application No. 2005-305827, filed on Oct. 20, 2005, the entire contents of which are incorporated herein by reference.

### BACKGROUND OF THE INVENTION

The present invention relates to a receiver and communication system and, more particularly, to a receiver and communication system suitable for an apparatus using space division multiplexing.

An SDM communication system using space division multiplexing (to be simply referred to as SDM hereinafter) in which a transmitter codes and multiplexes different signals and transmits them from a plurality of antennas and a receiver receives and decodes the multiplexed signals adopts a sphere decoder as a quasi-maximum-likelihood decoder for lattice codes as described in non-patent reference 1 cited below.

The sphere decoder uses a tree search algorithm to narrow down the transmitted lattice code points to one while gradually reducing the searching area. The use of the sphere decoder can achieve almost the same decoding precision as that of maximum-likelihood decoding at lower cost of decoding in comparison with exhaustive search. The sphere decoder targets a searching area inside the sphere.

In the use of the searching algorithm, it is conventionally difficult to decrease the number of searching calculations. An increase in the number of searching calculations raises the calculation cost.

In wireless communication, when normally receiving a packet, the receiving side transmits delivery confirmation (Ack) to the transmitting side.

If the receiving side cannot normally receive a packet and a packet error occurs, the receiving side transmits a packet re-transmission request (Nak) to the transmitting side or does not transmit any delivery confirmation (Ack). A technique of automatically re-transmitting a packet from the transmitting side in this case is called an automatic repeat request (to be referred to as an ARQ hereinafter).

According to a technique described in non-patent reference 2 cited below, the receiving side holds packet data with an error upon issuing an ARQ, and combines, with a weight, a total of N packets including the second, third, . . . , Nth (N is an integer of 2 or more) re-transmitted packets in addition to the first packet, decoding the transmitted packets. Communication using decoding data with an error and re-transmission data is called a hybrid ARQ.

In the hybrid ARQ, the transmitting side re-transmits a packet to the receiving side upon issuing an ARQ. The receiving side combines held packet data with an error and the re-transmitted packet data.

SDM communication using this method adopts an SDM decoder. In this case, the receiver can hold packet data with an error and combine it with re-transmitted packet data. However, the SDM decoder cannot perform a process using packet data with an error, failing to increase the efficiency of the decoding process.

The following are references which disclose a conventional sphere decoder and hybrid ARQ:

A universal lattice code decoder for fading channels Viterbo, E.; Bouros, J.; Information Theory, IEEE Transactions on, Volume: 45, Issue: 5, July 1999, Pages 1639-1642

Code Combining—A Maximum-Likelihood Decoding Approach for Combining an Arbitrary Number of Noisy Packets DAVID CHASE; Communications, IEEE Transactions on, Vol. Com-33, No. 5, May 1985, Pages 385-393

### SUMMARY OF THE INVENTION

According to one aspect of the present invention, there is provided a receiver comprising: a decoding unit having a quasi-maximum-likelihood decoder which receives a plurality of transmission signals transmitted simultaneously from a plurality of antennas, decodes the transmission signals using a searching algorithm, and outputs decoded signals, an error packet data storage unit which stores packet data with an error from the quasi-maximum-likelihood decoder when a packet error exists in the decoded signals, and a control unit which controls operations of the quasi-maximum-likelihood decoder and the error packet data storage unit; a receiving unit which receives the decoded signals, and when a packet error exists in the decoded signals, outputs a packet error detection signal to the control unit, wherein when said receiving unit outputs the packet error detection signal and receives re-transmitted transmission signals, the re-transmitted transmission signals are decoded using the error packet stored in the error packet data storage unit as a start point for search.

According to another aspect of the present invention, there is provided a communication system comprising: a transmitter having a plurality of antennas, a transmitting unit which transmits different transmission signals from the respective antennas, a transmission data storage unit which stores data of the transmission signals transmitted from the transmitting unit, and a transmitting-side control unit which controls operations of the transmitting unit and the transmission data storage unit; and a receiver having a decoding unit having a quasi-maximum-likelihood decoder which receives the transmission signals transmitted from the transmitting unit, decodes the transmission signals using a searching algorithm, and outputs decoded signals, an error packet data storage unit which stores packet data with an error from the quasi-maximum-likelihood decoder when a packet error exists in the decoded signals, and a receiving-side control unit which controls operations of the quasi-maximum-likelihood decoder and the error packet data storage unit, and a receiving unit which receives the decoded signals, and when a packet error exists in the decoded signals, outputs a packet error detection signal to the receiving-side control unit, wherein when said receiver outputs the packet error detection signal, the error packet data storage unit stores an error packet corresponding to the packet error detection signal and said receiver transmits a re-transmission request to said transmitter, when receiving the re-transmission request, said transmitter re-transmits the transmission signals using data stored in the transmission data storage unit, and when receiving the re-transmitted transmission signals, said receiver decodes the re-transmitted transmission signals using the error packet stored in the error packet data storage unit as a start point for search.

### BRIEF DESCRIPTION OF THE DRAWINGS

FIG. 1 is a block diagram showing the arrangement of a communication system according to the first embodiment of the present invention;

FIG. 2 is a block diagram showing the arrangement of a communication system according to the second embodiment of the present invention;

FIG. 3 is a block diagram showing the arrangement of a communication system according to the third embodiment of the present invention;

FIG. 4 is an explanatory view showing procedures to add packet data to a re-transmission signal in the third embodiment; and

FIG. 5 is a block diagram showing the arrangement of a communication system according to the fourth embodiment of the present invention.

### DETAILED DESCRIPTION OF THE INVENTION

Embodiments of the present invention will be described below with reference to the accompanying drawings.

### (1) FIRST EMBODIMENT

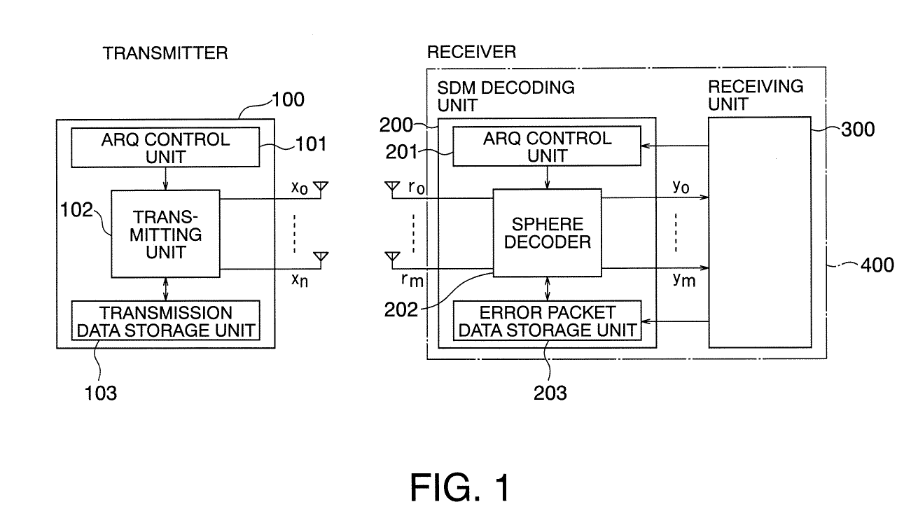

FIG. 1 shows the arrangement of a communication system according to the first embodiment of the present invention. The communication system comprises a transmitter 100 having an ARQ control unit 101, n+1 (n is an integer of 1 or more) transmission antennas x0 to xn, a transmitting unit 102, and a transmission data storage unit 103, and a receiver 400 having m+1 (m is an integer of 1 or more) reception antennas r0 to rm, an SDM decoding unit 200, and a receiving unit 300.

The SDM decoding unit 200 comprises an ARQ control unit 201, sphere decoder 202, and error packet data storage unit 203.

An operation in a normal communication state when normally transmitting/receiving data will be explained. The transmitter 100 simultaneously transmits transmission signals x0 to xn having independent data from the transmission antennas x0 to xn. At this time, to prepare for a case of issuing an ARQ, the transmission data storage unit 103 stores what kind of data was transmitted.

The stored transmission data can take any format as far as a transmitted packet can be reconstructed later. For example, the transmission data storage unit 103 may store the coded transmission signals x0 to xn directly, or data information before coding.

The receiver 400 receives signals transmitted from the transmitter as combined signals by the reception antennas r0 to rm.

The sphere decoder 202 decodes the received combined signals into signals y0 to ym. At this time, the sphere decoder 202 receives the radius d of sphere as an initial value, searches the inside sphere, and estimates, i.e., decodes the combined signals. The sphere decoder 202 outputs the obtained decoded signals y0 to ym to the receiving unit 300.

An operation upon issuing an ARQ will be described. When the receiving unit 300 detects a packet error in the decoded signals y0 to ym supplied from the sphere decoder 202, it outputs a packet error detection signal to the ARQ control unit 201.

Upon reception of the packet error detection signal, the ARQ control unit 201 operates to supply the decoded signals y0 to ym containing the detected packet error to the error packet data storage unit 203, which stores them. The receiver transmits a re-transmission request Nak to the transmitter.

When the transmitter 100 receives the re-transmission request, the ARQ control unit 101 operates to issue the re-transmission request to the transmitting unit 102. The transmitting unit 102 reads out original transmission data of the error packet from the transmission data storage unit 103, generates transmission signals x0 to xn identical to the signals of the error packet, and transmits them to the receiver 400.

In the SDM decoding unit 200, the ARQ control unit 201 operates to notify the sphere decoder 202 to receive re-transmission packets. In response to this, the sphere decoder 202 receives the signals x0 to xn transmitted as re-transmission packets as the combined signals r0 to rm. The sphere decoder 202 reads out the previously decoded signals y0 to ym stored in the error packet data storage unit 203, without using the radius d of sphere serving as the initial value of search. The sphere decoder 202 decodes the combined signals r0 to rm again using the decoded signals y0 to ym as a start point of the lattice points within the sphere.

The decoded signals y0 to ym stored in the error packet data storage unit 203 also include the closest point or a point near the closest point. When, therefore, the decoded signals y0 to ym include the closest point, search is executed using them as a start point for search that is one of the transmitted lattice code points. Search is highly likely to end by one calculation.

Even if the decoded signals y0 to ym do not include the closest point, they often include a point near the closest point. By using the decoded signals y0 to ym as a start point for search, search can start from the vicinity of the closest point.

Especially when normal communication has been achieved before issuing an ARQ, it is can be estimated that the closest point exists at high probability, more accurately, at a probability close to the coding rate of the error correcting code.

The first embodiment executes search again using packet data with an error upon issuing an ARQ, and can perform a decoding process more efficiently than a conventional method of starting search by giving the radius d of sphere.

As described above, a decoding process using a searching algorithm requires a higher cost of decoding as the number of searching calculations increases, so it is desirable to minimize the number of searching calculations. The communication apparatus according to the first embodiment employs packet data with an error as a start point for search of the quasi-maximum-likelihood decoder by giving attention to the fact that decoded signals stored in the error packet data storage unit include the closest point or a point near the closest point. Compared to the conventional method of starting search by giving the radius d of sphere, the calculation cost greatly reduces to contribute to reducing power consumption.

### (2) SECOND EMBODIMENT

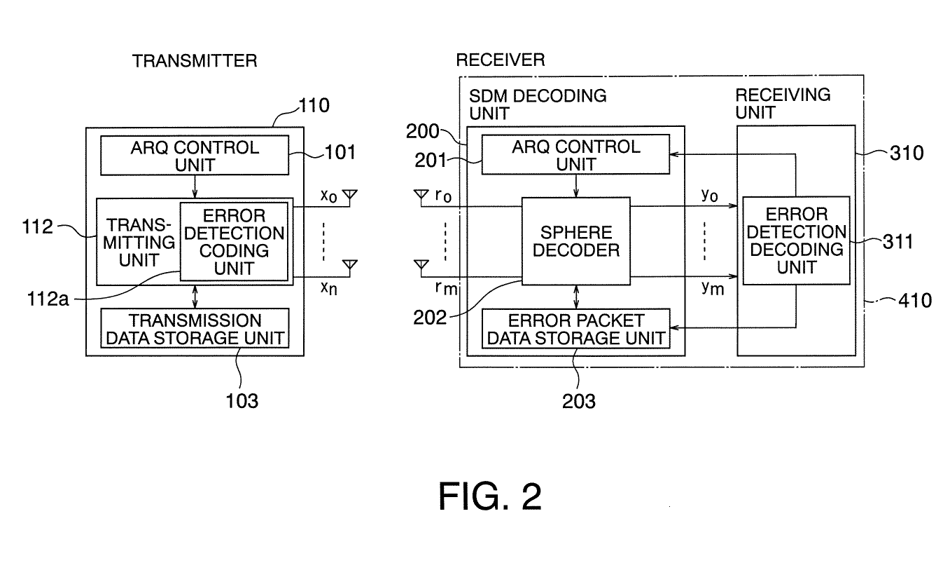

FIG. 2 shows the arrangement of a communication apparatus according to the second embodiment of the present invention.

The second embodiment is different from the first embodiment in that a transmitting unit 112 in a transmitter 110 incorporates an error detection coding unit 112a and a receiving unit 310 incorporates an error detection decoding unit 311 paired with the error detection coding unit 112a.

In order to allow the receiving unit 310 to determine whether the decoded signals y0 to ym contain a packet error, the transmission signals x0 to xn from the transmitter 110 must contain an error detecting code. Typical examples of this code are a CRC check and parity check. The error detecting code may have error correctability.

The error detection coding unit 112a codes the transmission signals x0 to xn such that they contain an error detecting code.

When the receiving unit 310 receives the decoded signals y0 to ym from the sphere decoder 202, the error detection decoding unit 311 decodes the error detecting code contained in the decoded signals y0 to ym to determine whether a packet error exists. If the error detection decoding unit 311 determines that a packet error exists, the same operation as that in the first embodiment is executed.

In the communication apparatus according to the second embodiment, the transmitter 110 performs an error detection coding process and the receiving unit performs an error detection decoding process, thereby detecting a packet error. By giving packet data with an error as a start point for search of the quasi-maximum-likelihood decoder, similar to the first embodiment, the calculation cost greatly reduces to achieve low power consumption, in comparison with the case of starting search by giving the radius d of sphere.

### (3) THIRD EMBODIMENT

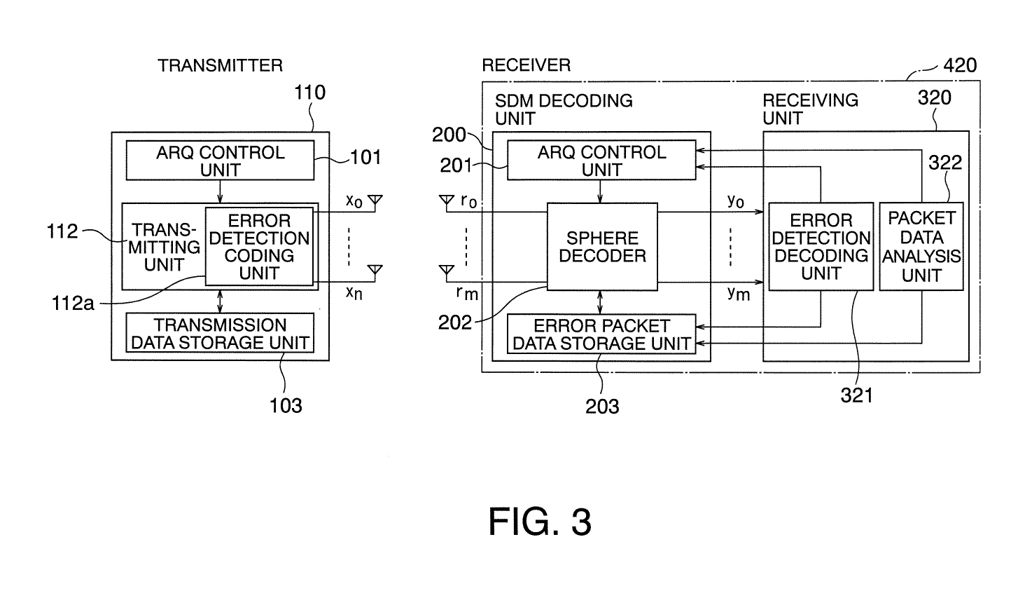

FIG. 3 shows the arrangement of a communication apparatus according to the third embodiment of the present invention.

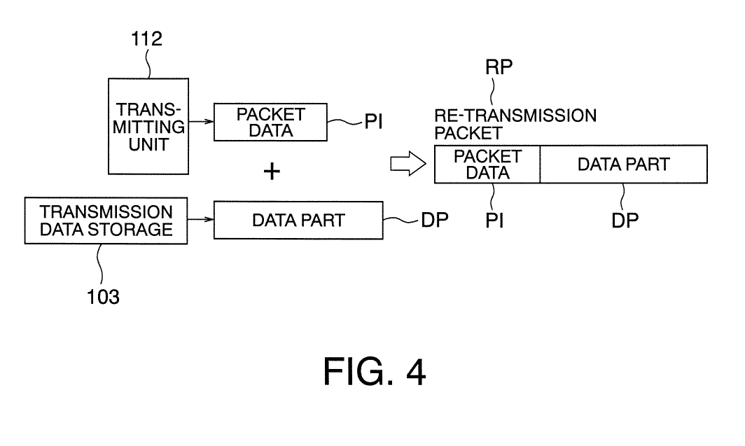

The third embodiment is different from the second embodiment in that a receiving unit 320 in a receiver 420 additionally comprises a packet data analysis unit 322. FIG. 4 shows procedures to add packet data to the transmission signals x0 to xn in re-transmitting them.

In the information communication field, packet data describing a packet source, destination, packet number, and the like is generally set at the start of a packet (e.g., IEEE 802.11a, 11b, 11g). Also when an ARQ is issued, packet data describing the ordinal number of a packet to be re-transmitted or the like is added. The present invention is also applicable to a case of issuing an ARQ during burst communication.

A transmission data storage unit 103 stores only a data part DP. If an ARQ is issued, the data part DP stored in the transmission data storage unit 103 is read out. The readout data part DP is concatenated to packet data PI to generate a re-transmission packet RP. The re-transmission packet RP is re-transmitted as the transmission signals x0 to xn.

The receiver receives the transmission signals x0 to xn as the combined signals r0 and rm. A sphere decoder 202 decodes the data part DP and packet data PI similarly to a normal operation, outputting the decoded signals y0 to ym.

The receiving unit 320 receives the decoded signals y0 to ym, and the packet data analysis unit 322 analyzes the packet data PI. If the packet data PI turns out to be the re-transmission packet RP, the packet data analysis unit 322 notifies an ARQ control unit 201 of this.

In the SDM decoding unit 200, packet data PI corresponding to the re-transmission packet RP is read out from the error packet data storage unit 203 under the control of the ARQ control unit 201. The sphere decoder 202 uses the packet data PI as a start point for search and performs a decoding process.

These procedures allow utilizing, in decoding, packet data representing the number of a re-transmitted packet, a modulation method, and the like.

The communication system according to the third embodiment analyzes packet data added at the start of packet data, and can increase the process efficiency by effectively using data representing the number of a re-transmitted packet, a modulation method, and the like.

### (4) FOURTH EMBODIMENT

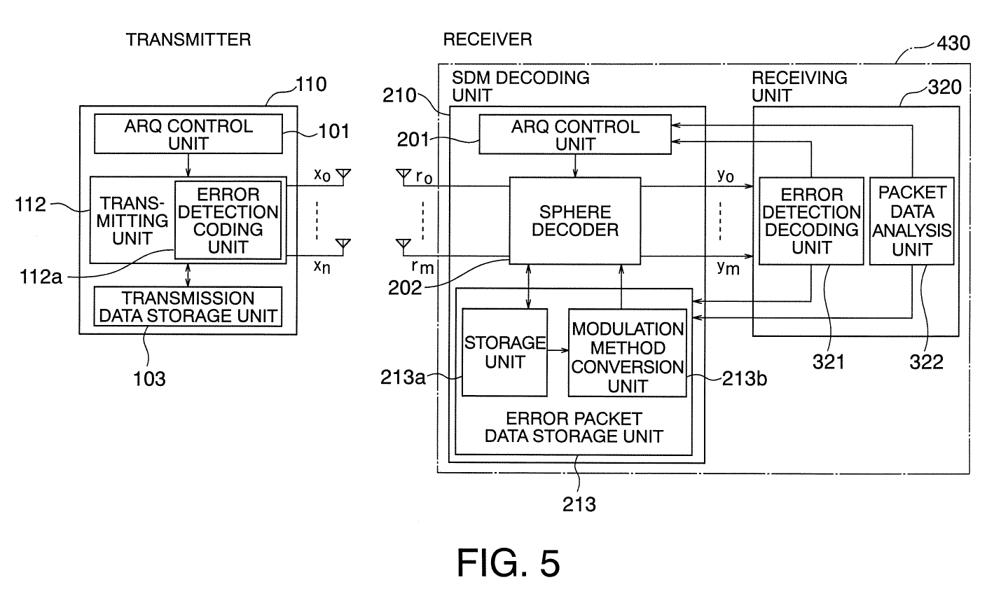

FIG. 5 shows the arrangement of a communication apparatus according to the fourth embodiment of the present invention.

The fourth embodiment is different from the first to third embodiments in that an error packet data storage unit 213 replaces the error packet data storage unit 203. The error packet data storage unit 213 comprises a storage unit 213a and modulation method conversion unit 213b.

The storage unit 213a stores an error packet, as described above.

When a modulation method used before generation of an error changes upon re-transmission of a packet, the modulation method conversion unit 213b converts the modulation method of an error packet before the change.

Generally in the information communication field, communication stabilizes by changing the modulation method to one for high performance under an AWGN (Additive White Gaussian Noise) for a sever transmission channel. In this case, the modulation method often switches at the timing when packet errors successively occur, i.e., ARQs are successively issued.

A change of the modulation method of a re-transmission packet after issuing an ARQ means a change of the transmission signals x0 to xn. In this case, the modulation method conversion unit 213b effectively converts the modulation method of an error packet stored before the change of the modulation method.

More specifically, the storage unit 213a of the error packet data storage unit 213 holds the decoded signals y0 to ym of an error packet.

If a packet data analysis unit 322 in a receiving unit 320 analyzes packet data to determine that the modulation method has changed, it notifies the error packet data storage unit 213 of the change of the modulation method.

The modulation method conversion unit 213b receives the decoded signals y0 to ym of the error packet stored in the storage unit 213a, converts their modulation method before the change to the current modulation method after the change, and outputs the resultant decoded signals y0 to ym to a sphere decoder 202. The sphere decoder 202 utilizes the decoded signals y0 to ym having the converted modulation method as a start point for search, and performs a decoding process.

For example, assume that the modulation method changes from 16QAM to QPSK after issuing an ARQ. The storage unit 213a stores a 16QAM-modulated symbol. The modulation method conversion unit 213b temporarily returns the 16QAM symbol read out from the storage unit 213a to a binary sequence. For example, when the 16QAM symbol is “3+1i”, the modulation method conversion unit 213b returns it to a binary sequence “1011”.

Then, the modulation method conversion unit 213b converts the binary sequence into QPSK. For example, the modulation method conversion unit 213b converts the binary sequence “1011” into QPSK symbols “1−1i, 1+1i”. For another modulation method, the modulation method conversion unit 213b can convert a symbol by the same procedures.

Modulation methods in a broader sense also include the coding rate. The coding rate is a value representing the number of times a data amount of original data increases by an error correcting code. An example of the method of changing the coding rate is puncturing. Puncturing is to regularly puncture bits and obtain a bit sequence at a desired coding rate.

As bits are punctured, performance under the AWGN decreases. Noise resistance is generally increased by transmitting bits, which were punctured upon issuing an ARQ, when re-transmitting a packet.

The positions of bits to be punctured are regularly arrayed at each coding rate. Bit puncturing positions can, therefore, be known by analyzing packet data. When the transmission signal of an error packet is punctured and that of a re-transmission packet is not punctured, the sphere decoder 202 receives the radius d of sphere to perform a normal operation for bit data at punctured positions upon generation of an error packet. As for the remaining bit data, the storage unit 213a holds the data upon generation of an error packet, and supplies the data as a start point for search to the sphere decoder 202.

An ARQ control unit 201 and the error packet data storage unit 213 execute these control operations. The ARQ control unit 201 supplies the start searching area d to the sphere decoder 202 when bit data are depunctured to decode the punctured bit positions. In other cases, the ARQ control unit 201 performs decoding using a value read out from the error packet data storage unit 213 as a start point for search. These procedures can implement a hybrid ARQ.

By performing a corresponding process, the communication apparatus can also cope with a case of changing the modulation method and also puncturing bits.

Even when the modulation method changes to one other than the above-mentioned QAM modulation, the fourth embodiment is applicable similarly to the above-described method as far as the difference between modulation methods is calculable. The fourth embodiment can also deal with a case of interleaving bits.

As described above, in the communication apparatus according to the fourth embodiment, when the transmission signals x0 to xn are re-transmitted by changing their modulation method upon issuing an ARQ, the modulation method conversion unit 213b converts the modulation method of the decoded signals y0 to ym containing a generated packet error before the change. The difference in modulation method between decoded signals y0 to ym based on a modulation method before the change stored in the storage unit 213a of the error packet data storage unit 213 and decoded signals y0 to ym re-transmitted after changing the modulation method can be used as a start point for search of the quasi-maximum-likelihood decoder. Thus, the decoding process can achieve high speed even upon a change of the modulation method in re-transmitting the transmission signals x0 to xn.

As has been described above, the receiver and communication system according to the above embodiments can increase the efficiency of the decoding process using packet data with an error.

The above-described embodiments are merely examples, may not be construed to limit the scope of the present invention, and can be variously modified within the technical scope of the invention.

For example, the first to fourth embodiments adopt a sphere decoder as a quasi-maximum-likelihood decoder. However, the present invention is not limited to the sphere decoder, and even a quasi-maximum-likelihood decoder of another search type which narrows down, e.g., a rectangular block area to obtain a searching area can attain the same effects as those of the first to fourth embodiments by performing a decoding process using the decoded signals y0 to ym containing a generated packet error as a start point for search.

What is claimed is:

1. A receiver comprising:
a decoding unit having a quasi-maximum-likelihood decoder which receives a plurality of transmission signals transmitted simultaneously from a plurality of antennas, decodes the transmission signals using a searching algorithm, and outputs decoded signals, an error packet data storage unit which stores packet data with an error from the quasi-maximum-likelihood decoder when a packet error exists in the decoded signals, and a control unit which controls operations of the quasi-maximum-likelihood decoder and the error packet data storage unit;
a receiving unit which receives the decoded signals, and when a packet error exists in the decoded signals, outputs a packet error detection signal to the control unit,
wherein when said receiving unit outputs the packet error detection signal and receives re-transmitted transmission signals, the re-transmitted transmission signals are decoded using the error packet stored in the error packet data storage unit as a start point for search.

2. A receiver according to claim 1, wherein
the re-transmitted transmission signal contains a code for detecting the packet error, and
said receiving unit comprises an error detection decoding unit which performs decoding on the basis of the code for detecting the packet error and determines whether the transmission signal contains a packet error.

3. A receiver according to claim 1, wherein
said receiving unit comprises a packet data analysis unit which analyzes packet data contained in the re-transmitted transmission signal, determines whether a packet is a re-transmission packet, and outputs a determination result, and
in said decoding unit, packet data corresponding to packet data contained in the re-transmitted transmission signal is read out from the error packet data storage unit under control of the control unit, and the quasi-maximum-likelihood decoder performs a decoding process using the readout packet data as a start point for search.

4. A receiver according to claim 2, wherein
said receiving unit comprises a packet data analysis unit which analyzes packet data contained in the re-transmitted transmission signal, determines whether a packet is a re-transmission packet, and outputs a determination result, and
in said decoding unit, packet data corresponding to packet data contained in the re-transmitted transmission signal is read out from the error packet data storage unit under control of the control unit, and the quasi-maximum-likelihood decoder performs a decoding process using the readout packet data as a start point for search.

5. A receiver according to claim 1, wherein the error packet data storage unit comprises
a storage unit which stores the packet data with an error, and
a modulation method conversion unit which, when a modulation method of the re-transmitted/received transmission signal is changed, converts a modulation method of the error packet stored in the storage unit into the changed modulation method.

6. A receiver according to claim 2, wherein the error packet data storage unit comprises
a storage unit which stores the packet data with an error, and
a modulation method conversion unit which, when a modulation method of the re-transmitted/received transmission signal is changed, converts a modulation method of the error packet stored in the storage unit into the changed modulation method.

7. A receiver according to claim 3, wherein the error packet data storage unit comprises
a storage unit which stores the packet data with an error, and
a modulation method conversion unit which, when a modulation method of the re-transmitted/received transmission signal is changed, converts a modulation method of the error packet stored in the storage unit into the changed modulation method.

8. A receiver according to claim 4, wherein the error packet data storage unit comprises
a storage unit which stores the packet data with an error, and
a modulation method conversion unit which, when a modulation method of the re-transmitted/received transmission signal is changed, converts a modulation method of the error packet stored in the storage unit into the changed modulation method.

9. A communication system comprising:
a transmitter having a plurality of antennas, a transmitting unit which transmits different transmission signals simultaneously from the respective antennas, a transmission data storage unit which stores data of the transmission signals transmitted from the transmitting unit, and a transmitting-side control unit which controls operations of the transmitting unit and the transmission data storage unit; and
a receiver having
a decoding unit having a quasi-maximum-likelihood decoder which receives the transmission signals transmitted from the transmitting unit, decodes the transmission signals using a searching algorithm, and outputs decoded signals, an error packet data storage unit which stores packet data with an error from the quasi-maximum-likelihood decoder when a packet error exists in the decoded signals, and a receiving-side control unit which controls operations of the quasi-maximum-likelihood decoder and the error packet data storage unit, and
a receiving unit which receives the decoded signals, and when a packet error exists in the decoded signals, outputs a packet error detection signal to the receiving-side control unit,
wherein when said receiver outputs the packet error detection signal, the error packet data storage unit stores an error packet corresponding to the packet error detection signal and said receiver transmits a re-transmission request to said transmitter,
when receiving the re-transmission request, said transmitter re-transmits the transmission signals using data stored in the transmission data storage unit, and
when receiving the re-transmitted transmission signals, said receiver decodes the re-transmitted transmission signals using the error packet stored in the error packet data storage unit as a start point for search.

10. A system according to claim 9, wherein
said transmitter comprises, in the transmitting unit, an error detection coding unit which performs a coding process so as to contain a code for detecting a packet error in a transmission signal, and
said receiver comprises, in the receiving unit, an error detection decoding unit which performs decoding on the basis of the code for detecting the packet error that is contained in the transmission signal, and determines whether the transmission signal contains a packet error.

11. A system according to claim 9, wherein
said transmitter generates packet data upon receiving the re-transmission request, and re-transmits the transmission signal containing the packet data and data stored in the transmission data storage unit,
said receiver comprises a packet data analysis unit which analyzes packet data contained in the re-transmitted transmission signal, determines whether a packet is a re-transmission packet, and outputs a determination result, and
in the decoding unit, packet data corresponding to packet data contained in the re-transmitted transmission signal is read out from the error packet data storage unit under control of the receiving-side control unit, and the quasi-maximum-likelihood decoder performs a decoding process using the readout packet data as a start point for search.

12. A system according to claim 10, wherein
said transmitter generates packet data upon receiving the re-transmission request, and re-transmits the transmission signal containing the packet data and data stored in the transmission data storage unit,
said receiver comprises a packet data analysis unit which analyzes packet data contained in the re-transmitted transmission signal, determines whether a packet is a re-transmission packet, and outputs a determination result, and
in the decoding unit, packet data corresponding to packet data contained in the re-transmitted transmission signal is read out from the error packet data storage unit under control of the receiving-side control unit, and the quasi-maximum-likelihood decoder performs a decoding process using the readout packet data as a start point for search.

13. A system according to claim 9, wherein the error packet data storage unit comprises
a storage unit which stores the packet data with an error, and
a modulation method conversion unit which, when a modulation method of the re-transmitted/received transmission signal is changed, converts a modulation method of the error packet stored in the storage unit into the changed modulation method.

14. A system according to claim 10, wherein the error packet data storage unit comprises
a storage unit which stores the packet data with an error, and
a modulation method conversion unit which, when a modulation method of the re-transmitted/received transmission signal is changed, converts a modulation method of the error packet stored in the storage unit into the changed modulation method.

15. A system according to claim 11, wherein the error packet data storage unit comprises
a storage unit which stores the packet data with an error, and
a modulation method conversion unit which, when a modulation method of the re-transmitted/received transmission signal is changed, converts a modulation method of the error packet stored in the storage unit into the changed modulation method.
